(19) United States
(12) Patent Application Publication
(10) Pub. No.: US 2010/0324982 A1
(43) Pub. Date: Dec. 23, 2010

(54) METHOD AND SYSTEM TO OFFER BEST PRICE DEAL AND SHARP TARGETED POINT OF PURCHASE ADVERTISEMENT IN E-RETAIL WEBSITE

(76) Inventor: Vivek K Marolli, Navi Mumbai (IN)

Correspondence Address: NWAMU, P.C., 360 Grand Ave, Suite 109, Oakland, CA, 94610, US

(21) Appl. No.: 12/596,622

(22) PCT Filed: Apr. 19, 2008
(86) PCT No.: PCT/IB08/51515

§ 371 Date: Mar. 19, 2010

(30) Foreign Application Priority Data
Apr. 19, 2007 (IN) 762/MUM/2007

(51) Int. Cl. G06Q 30/00

(52) U.S. Cl. 705/14.23; 705/26.61; 705/14.51; 705/14.48

(57) ABSTRACT

A Unique E-Retail System for Customers of Branded Products and Services that Serves as a Point of Purchase Advertising Medium that identifies ‘interested’ Customers based on an uniquely tracked Brand Choice Behavioral Targeting software program and further inducing them to take buying decisions in a brand's favor by offering Brand wise Sales Incentives calculated based on a forward Action Algorithm in proportion to the Ad Spends by each brand on the site, which in effect leads to better Price Deals to Customers on these Branded Products and Services.

### FIELD OF INVENTION

This invention relates to online e-commerce for only branded products and services with large advertising budgets. More particularly, the invention relates to the method of offering best price and Sharp Targeted Point of Purchase advertisement through e-retail website on the internet.

The products available may include Automobiles, Consumer Durables, Electronic Goods, Financial Products, Jewelry, Fashion Apparel, Footwear, Travel, Entertainment, Health and Food Products.

### BACKGROUND OF THE INVENTION

About Conventional E-Commerce:

Electronic Commerce (E-commerce) is a term exactly analogous to a marketplace on the internet consisting primarily of the buying/selling, marketing, distributing and servicing of products or services over electronic systems such as the Internet and other computer networks. E-commerce typically uses electronic communications technology of the World Wide Web as a means of conducting the ‘monetary exchange’ in the transaction's lifecycle.

While E-commerce has garnered mass based acceptance for several categories such as Books, Music, Air Tickets, Flowers, and certain types of branded/niche products that can be delivered to the Customer's door step through a physical delivery system, there are many other categories particularly, consumer durables and other high value/bulky product categories demanding a high involvement purchase decision which have not yet succeeded in being able to be sold or purchased over the Internet through a pure E-Commerce process. For Example, product categories where online commerce has not yet been fully successful include consumer durables such as automobiles, high value home electronic goods, house hold appliances, consumer durables etc. The reasons for this are primarily the lack of complete information both about the product and the seller, to enable the buyer to take a sensible purchase decision. Also unless there is a better price deal advantage offered to a customer on such categories compared to the price at which the same product is available at a local retail store, a customer would not see the merit in purchasing such products through an online e-commerce service, particularly due to the risk involved in taking a wrong purchase decision.

Currently most mass based E-Commerce websites restrict it selves to selling products where they are able to give a better price deal to a customer. E-commerce Businesses usually buy products in larger volumes from the manufacturer at a lower price and give the online customer a better price deal—Lower price that what is possible for the same product in an off-line retail store. This in turn means holding large inventories of such products and delivering it to the customer at his door-step through a physical delivery system.

Some Drawbacks with Existing E-Commerce Methods:

1. Customers are comfortable when buying products which they can never go wrong with when purchased online—E.g. Books, Music, Movies, Software, Air Tickets etc. But for other categories of products where the touch and feel is more important or perhaps a more involved decision making process is required based on a good understanding of the product's technical specifications, or in some cases the reliability of the seller or dealer, or in most cases, proper and complete information on the price etc, the customer finds it difficult to take a sure shot buying decision.

2. In most e-Commerce websites of Multi Brand Consumer Products, the Customer gets limited choice of brands when he is looking for a best price deal. This is because the E-Commerce service provider bargains a low wholesale price deal with brand manufacturers by purchasing products in large quantities. If multiple brands are to be purchased it would reduce the quantity and then a lower price cannot be bargained. Therefore, they prefer to offer the service with limited brands/models only—leaving the customer with very little choice if he wants a low price deal.

3. Existing methods of e-retail and e-commerce don't deal with bulky products such as refrigerator, automobiles because the logistics are difficult to manage and deliver through a physical distribution system. Hence most e-retail ventures are confined to lower value products, such as mobile phones, cameras and computers that can be delivered to the customer through a physical logistics delivery system.

4. When a customer buys a high value product like a refrigerator or a car, he would seldom make a full down payment. He would in most cases be interested in taking a mortgage loan to make the payment in easy monthly installment. Existing E-Retail ventures cannot support such services and need the customer to make a full down payment. This is considered acceptable in the current e-commerce scenario which only deals with low value products where a customer can make a full down payment.

5. Large format organized E-retail systems and also e-retail systems set up by the manufacturers or e-retail service providers eliminates the need for the dealers/retailers/distributors. Therefore this system in some sense attempts to disrupt the conventional distribution process and supply-chain that has been in practice for decades.

6. The limitation with existing E-commerce ventures is that, since it depends on physical inventories to be maintained and actual distribution to be made to every customer's door step, these e-retail ventures will have to limit their services to large towns and cannot penetrate down to up-country smaller towns across geographical scattered distances as the inventory and cost of physical distribution make the venture unviable.

### Role of Advertising to Brand Marketers:

In the case of brand marketers, the main objective is to increase sales of their products and increasing customer satisfaction. With a view to increase sales, most branded products have substantial advertising budgets which aim to inform prospective target customers about the unique benefits of the brand/product. These advertising budgets are spent in mass media such as Newspapers, Print Magazines, Television, Radio, Outdoor, Cinema, Internet and other similar mediums. Over the years media options for customers have exploded exponentially. There is a high degree of information overload due to the plethora of media communications bombarding customer's every day. Customers are increasingly getting immune to intrusive advertising that interrupt them when they are least interested. As a result of this media fragmentation, the cost of reaching an interested customer has become very high today. With the rising cost of advertising, the Brand Manufacturer has to spend substantial higher amount of money to attract customers to buy their brands.

### Drawbacks:

There is an exorbitant wastage of the Brand's advertising budget, in talking to Customers who are not interested in the Product/Brand. This in turn means that even for the interested customer, the cost of the brand/product goes up because of the higher cost of advertising and marketing to the manufacturer. If the cost of advertising and marketing can reduce without reducing the sales of the brand for the manufacturer, then customers can enjoy purchasing these brands at lower costs than what it is available at today.

### SUMMARY OF THE INVENTION

The present invention overcomes all the problems with the prior art by providing a method and system to offer best price deal and sharp targeted point-of-purchase advertisement in e-retail website that offers the customers, a multi-brand, multi-seller competitive marketplace where customers choose to buy any branded product at the best price deal from any of the multiple dealers in his city, selling the product through the site.

As customers make their final purchase decision on which brand to buy within the site, it becomes a unique point of purchase medium for brand marketers who can target their brand advertising to customers based on Behavioral Targeting of their brand choices that eventually leads to a purchase decision.

The invention employs a unique forward auction model that allows the advertiser to bid (and commit) on the brand's advertisement budgets through the site. Depending on the Brand's Committed Advertisement Budget the site calculates the sales incentives to customers who choose to buy this brand. The higher the Brand's Advertisement Budget, the higher will be the Sales incentive. As the Sales Incentive to the Customers increase with the increase in the brand's Advertisement Budget, it also directly increases the brand's sales on the site. These sales incentives will be in the form of reward points and get added to the Customer's account and can be redeemed against future purchases on the site. As the process gives advertisers a direct correlation between money being spent on advertising and actual sales there is minimum advertisement spend wastage.

The invention utilizes a unique algorithm for calculation of Brand's Sales Incentives (or reward points) in comparison with the advertisement budget bid of multiple competing brands. Once the budget is set and the Reward points are fixed for the brand, the Advertiser will be able to use a unique advertisement management system to independently manage their competitive strategic campaigns targeted to maximize sales of their brands in the site.

The sales incentives (in the form of reward points) are given to the customers over and above the best price deals offered by multiple retailers selling the products on the site. The customer can choose any dealer of her convenience and still earn the reward points as an additional incentive, making it the best deal on that brand/product that he can ever get in his city.

In order to accomplish the above, the system has a uniquely developed back end system that can aggregate multiple dealers/retailers to manage their shops with products and the best price deal they want to offer customers.

The product information, photographs and videos are managed by the e-retail administration manager and the prices offered by the dealers and retailers are approved so that the customer always gets the best price deal that is promised by the system. Every order is managed by the e-retail administration manager through a collaborative process between the customer and the dealer with whom the customer has placed the order.

### DETAILED DESCRIPTION OF THE INVENTION

The system brings together multiple parties in the supply chain into a collaborative relationship designed to mutually benefit everybody who are part of the network. The process is described user wise as below:

### (A) MANUFACTURER (BRAND MARKETER/ADVERTISER)

### (B) END CUSTOMERS

### (C) DEALERS/DISTRIBUTORS/RETAILERS

### (D) E-COMMERCE SERVICE PROVIDER

### (A) For the Manufacturer (Brand Marketer/Advertiser)

The present invention provides a unique platform for advertisers by giving them interested customers at point of purchase and allowing them to reduce wastage of their advertisement budget like the way it happens in other conventional mass mediums. And to the customer, it makes available brands/products that they are interested in, at a better price deal.

Brand Marketers/Advertisers can forward auction by placing bids for higher advertising budget to be spent on the site for a specific period. Every Brand Marketers/Advertisers has a brand wise account within the system, where he can login and place his Advertisement Spend Bids at any time. Based on unique software driven process, the system ranks advertisers of competitive brands in reducing order, based on various parameters including the value of their committed Advertisement spends on the site and consistency of spending. The brand with the highest advertisement spend rank gets the highest sales incentive (in the form of Reward Points) that will get offered to every Customer purchasing that brand through the site. The Brand Marketers/Advertisers can increase the bid at anytime so that it increases the reward points for the brand. As every brand being sold on the site has reward points of different value calculated based on the advertisers advertisement spend bid submitted on the system, the customer can choose any brand he wants to buy and get reward points accordingly. The choice of which dealer to buy the product from does not affect the value of reward points earned by the customer upon purchasing that brand. In other words, the customer can choose any dealer based on the special price deal offered by that dealer and whichever dealer he chooses to buy the brand from, the reward points will be credited to the Customer's account. Higher the reward point on a brand, higher is a customer's intention to buy that brand. As reward points are calculated based on the Advertisement Budget Spend of each brand, the brand Marketer has a direct control over sales of his brand on the site by increasing his Advertisement Spend on the site.

If the brand has multiple model variants, the respective reward points for each variant will also be displayed. The Brand Marketers/Advertisers will also be able to view the Reward Points being offered for all other competitive brands, within a sub-category. For Example within a category say ‘Cars’, the sub-categories could be ‘Small Cars’, ‘Medium Size Cars’, ‘Luxury Cars’, ‘Super Premium’ based on varying price points at which various brands of cars on the site are being sold.

This unique system therefore, subsidizes the cost to the customer by reducing costs to the Brand Marketers/Advertisers by creating a one of its kind channel for online advertising that offers sharp focused targeted customers at point of purchase where result oriented advertising can be executed with minimal advertisement spent wastage.

Once the Brand Marketers/Advertisers finalize the Advertisement Budget he can submit the same. The e-retail administration manager then approves the bid after finalization of commercial terms. The next step is for the Advertiser to set up banner campaigns for the Brand.

As customers can make their pre-purchase brand choices and final purchase decision while browsing the site, it becomes a point of purchase medium for brand marketers and advertisers. The intelligent tracking system on the site offers advertisers a unique platform for targeting their brand advertising based on the customers brand choice behavior (Behavioral Targeting) on the site across different pages leading to the purchase decision.

The site has within it a number of sections for the customer to browse through during his decision making process of which brand to place an order for. These pages provide different types of information about the product to the customer and also needs the customer to interact with by clicking various links and make his choices. Based on the closeness to a decision finalization, these pages are classified into multiple clusters (or groups) of varying importance. There are multiple pages in each cluster. Every page also has multiple advertising banner options. All this translates into multiple options for the advertiser to place his banner ads at varying price points depending on the sub category, type of cluster chosen and the type of banner advertising preferred.

When the advertiser sets up multiple competitive brand communication campaigns that vary, depending upon the other competitive brands that the customer is/was interested in, as tracked by his browsing patterns in the current session as well as in the past sessions. For E.g. Brand X can target its advertising against brands A and B within a sub category “Small Cars” and E and F within Sub Category “Medium Size Cars”. This means that when a Customer's behavior on the site indicates his interest for brands A, B, E or F, then banners of Brand X will get served to this customer (as required by the Marketer of Brand X)

The rates at which an advertiser can purchase banner impressions (or advertisement inventory) on the site is driven by an uniquely developed Software Program Algorithm which works on the basis of demand and supply of advertisement inventory at any given point in time. In other words if an advertiser wishes to buy about 10,000 impressions in a specific section within the site, the Algorithm first Estimates the available number of impression for that particular period. The method to determine price of said advertisement banners that appear on a particular web page, comprises of the steps of requiring the Advertiser to login into his Login Account and complete his campaign set up for his brand across all Advertising options on the online site so as to assign not less than 90% and not greater than 110% of his total committed brand budget for the current time period (usually 4 months). The process to complete set of the campaign for the Advertiser, involves set up of a Plurality of advertisements with a plurality of Creative Banner. Each Creative Banner of a certain size can be assigned to be displayed for a certain kind of Advertising within a certain Page Group. Further, the Advertiser can also Choose Customers Competitive Brand interest and can assign different Creative banners to different Customers—This means that in a page that a Customer is viewing brand information of a Competitor “Brand A”, sees a different Creative Banner vs. another Customer/or same customer viewing in another web page brand information of another Competitive Brand say “Brand B”. Advertiser has to Bid his Highest Price that he is willing to play for Display of a certain kind of Advertising within a certain Page Group and then choose the number of such banner impression that he wants to buy for that Advertisement. The system then computes the cost of each such Advertisement. Multiple such Advertisements set up by the Advertiser add up to complete the Campaign as the total value is at least 90% to 110% of the total Ad Budget. The Advertiser can edit his campaigns at any time, however the campaign is not “Complete” (at least 90% to 110%) it will not go live. The system Estimates on an everyday basis, the number of banner impression available on the e-retail website, within a category and sub category for the next day based on a past 45 day performance pattern of that sub category, for each type of advertising and for each group of pages. The system computes on an everyday basis the demand for the above said displays for the next day within each sub category—for each type of advertising and for each group of pages based on a plurality of campaigns set of all multiple brand advertisers in the same Category and sub category.

The system matches the demand for the next day based on Campaigns set with estimated Supply of Impressions for next day and there by computes the optimum price for banner impression. The advertisers would have quoted their max bid price for purchase of this inventory. System Serves Campaigns prioritizing Advertisers with higher bids. Based on the bid prices, the highest bid price based on which all the impressions can be sold becomes the base price and the banners get served based on this price. Such advertisers will be alerted in order to allow them to upgrade their bids for the next day.

Therefore if there are more Advertiser demand for impressions than there is Supply the Impression CPM (Cost per thousand) rates go up and vice versa.

The Demand—Supply Algorithm uses advanced mathematical calculations to ensure that at any point of time the Advertiser gets the lowest rate possible within the Competitive bidding scenario of multiple competitive brand advertisers managing their respective brand campaigns within the system.

Daily reports are provided to Advertisers to monitor the progress of their campaigns and the return on investments on the Advertisement Spends.

Multiple banner creative and even online advertisement films can be placed by the advertiser with a view to influence the customers buying decision in favor of his brand.

All this means that, the advertiser has in his access, a sharp focused bunch of target Customers at a critical Point of Purchase—who are in the process of buying one of the many brands that he is considering to buy. It is the advertiser's job to convince the customer through his advertising to choose his brand over the competitor's.

As multiple brands would be interested in influencing a customer's decision making process at the point of final purchase, the unique Advertisement Serving technology prioritizes campaigns on a bid value basis, wherein the highest advertising bidder for a brand ends up influencing the customer more by offering a higher sales incentive in the form of reward points. The final choice of course is entirely with the customer to decide which brand to buy at the special offer price and also which dealer to buy it from.

Hence both the manufacturer and the customers benefit. And the retailers/dealers benefits too as these increased sales are executed through their existing outlets thereby increasing their sales turnover.

### (B) For the Customer:

The service means a great deal of convenience and price savings to the customer.

A customer who intends to buy a product gets to view options from a wide choice of available brands, compare features across brands, get in-depth information about the brands of his choice and be able to take an intelligent purchase decision by making an online payment to place his order with a preferred dealer or retailer—all this within the confines of his home without having to visit any dealer or retail outlet.

The service also promises him the best deal that he can ever get for that product anywhere in his city.

Because the service offers best deals on branded consumer products, there will be a large number of customers who visit the web site everyday to place orders of brands or their choice. The service provides up-to-date information on a wide choice of brands in the market, cross-brand comparison features and best offers from different dealers and retailers made available to the customer on a city specific basis. This means that the customer can get all the necessary information without having to visit different dealer/retailer outlets as a one stop shop service.

Over and above the special deals offered by the dealer, the site offers further incentives in the form of reward points that get added to the customer's account and can be redeemed by him against purchase of other brands or products in the future.

In order to purchase using this system, a customer will need to have a registered account with the system. He can then browse through different products across various categories. He can search for products, shortlist brands that he is interested in, save them to a shortlist, or compare multiple brands for technical features and then look for best deals being offered by multiple dealers in his city.

The best deals page display a list of the special price offered by all the Dealers/Retailers who are officially part of the shopping network. Whichever dealer/retailer the customer decided to place his order with, the system offers an additional incentive to the customer in the form of reward points. These reward points are calculated by the system using a unique algorithm, which is based on the value and consistency of advertisement spends committed by the advertiser of that brand on the E-Commerce shopping site. Hence the reward points vary for different brands and also for different models. The reward points for each brand or product also increase or decrease everyday depending on further bids being done by competitive brands on an ongoing basis.

The customer can place his order with any dealer or retailer by simply paying the booking amount using a credit card. If the customer is interested in a mortgage loan or needs insurance (as in the case of Automobiles) he can state his preferences in the order form. Once the order is received by the e-retail administration manager, he uses the backend Enterprise Management system to process the order through a collaborative process between a customer service executive, the dealer and the customer. The customer service executive contacts the customer to process the order i.e., if needed, he organizes the loan and insurance, processes through Loan Company of customer's choice and makes the payment to the dealer. The product kept ready at the Dealer's end, for delivery. The customer then gets the product delivered by the dealer. The customer will now have to confirm acceptance of the delivery by logging on to the site. Once this is done, the order is closed and the reward points are credited to the customer's account.

If the customer want to redeem the points in his account against purchase of any other product, he has to simply choose a product that he plans to buy from the wide choice of brands and models available on the site. On booking the order, the system automatically checks the available reward points in the customer's account and validates him for the redemption. The difference in price can then be paid online by the customer. Upon redemption a 16 digit redemption code is mailed to the customer. The customer can now use this to place his order with any dealer/retailer within the network and go through the normal product delivery process.

The site will be advertised in mass media to get more customers to channelize their buying process through the site and avail of the best price deals offered by the site.

### (C) For the Dealer/Retailer/Seller:

As the system brings together a large number of customers interested in buying branded consumer products, the existing Dealers/Distributors/Retailers of these Brands can become registered members on the network and set up their e-shop where they can offer their best price and special offers to the customers.

It makes good business sense for dealers to use the system to increase their sales through Online E-Retail. Every Dealer can set up his e-shop within the network using an Enterprise Shop Management System where he can add all the brands he is in a position to sell along with details of his best price and special offers he wishes to give his customers. All dealer offerings will be city specific so that the customer can easily take delivery of the product from the dealer's outlet.

All prices quoted by the dealer will be moderated by the E-Retail service provider through the Enterprise Shop Management System, which ensures that every product ordered by the customer is delivered by the dealer at the committed price-deal. The dealer pays the E-Retail service provider for using the network and for every sale that he gets from the network.

While most E-commerce Retail Ventures of branded products attempt to eliminate the dealer Distributor/Retailer, the present invention makes the existing Dealer/Retailer part of the system. This in turn eliminates the logistical complexities and the high costs of inventory maintenance and distribution, so that this price savings can be passed on back to the customer. To enable this, the system works with existing dealers/retailers by making them part of the online network to serve are the distribution and delivery partners. The actual sale is hence executed through the existing physical outlet of the dealer/retailers whoever the customer chooses to place the order with.

Authorized Dealers of Branded Products are invited to join the network. A dealer shop account is set up for each dealer/retailer. At this point of set up the dealer is assigned the categories of products that he deals with. E.g. A car dealer is assigned the category “cars”. The dealer now can also assign himself to the list of brands he wants to deal with.

Once this initial set up is done, the dealer can log on to his shop management interface through the enterprise management system. The dealer gets to see all the products/models under the brands assigned to him. All product information such as technical specifications, images, videos, customer reviews and product brochures are already set up by the E-Retailer.

The dealer just has to set up his shop by selecting the models/products he wants to sell. For each brand/product he has to provide detailed price information including breakups as pre determined by the system. These breakups vary from product category to category and will have to be accordingly dealt with by the dealer.

The dealer will also have to specify the best price deal and special offers he wishes to give the customer. This information is then sent to the product price validation team of the e-retail administration manager. Incorrect prices are corrected through a fully automated web based system. And once approved the dealers shop goes live.

When a customer is searching for best deals on a particular product, this dealer's information and best deal comes up along with other dealers in the city who are part of the network. The customer can now choose which dealer he wants to place the order with. He can even contact the dealer directly for further information, before placing an order.

Once the order is received by the e-retail administration manager, he uses the backend Enterprise Management system to process the order through a collaborative process between a Customer Service Executive (CSE), the Dealer and the Customer. Once the product is delivered the customer will have to confirm acceptance of the delivery by logging on to the site. Once this is done the order is closed and the reward points are credited to the customer's account. After the order is closed the initial booking amount paid by the customer to the E-Retailer is credited into the dealer's account.

### (D) For the E-Commerce Service Provider:

The e-Commerce Service Provider who runs the venture plays multiple roles in the System:

On one side he should ensure that the customer gets quality and value that is in line with the promise of the service—“Best Deals on Branded Consumer Products”. The main job of the service provider is to get more and more customers to use the service. This will have to be effected through mass media advertising.

On the other side the e-Retail service provider has to ensure that the Dealers/Retailers get substantial sales through the network. The e-Retail service provider then will have to get more and more dealers/retailers to join the network. He will also have to ensure that all dealers on the network deliver a quality service to the customer. The system controls this entire enterprise process and is managed by a large team of Content Managers, System Managers, Price Validations, Advertisement managers and a ground level team of Sales executives and Customer service executives (CSE).

Thirdly the e-Retail Service Provider has to get Manufacturers/Marketers/Advertiser of the brands to use the network to the best of their advantage to maximize sales in proportion to their Advertisement spends on a brand by brand basis. This in turn means savings and greater return on investments to the brand advertiser and at the same time better deals to customers, who will then feel satisfied with the service and come back for more.

The present invention adds a lot of value in enhancing E-Retail Services through web based E-commerce aimed at selling branded products.
For Customers it means more convenience in buying branded products and at better price deals.
For manufacturers it offers a new way of reaching customers at point of purchase and using behavioral Targeting for brand advertising that directly impact sales.
For dealers, retailers and distributors, this means using the web based service to get more customers to buy the products at the outlets with shorter sales conversion cycles.

The e-Commerce Service Provider controls this entire Enterprise process and is managed by a large team of Content Managers, System Managers, Price Validations, Advertisement Managers and a ground level team of Sales Executives and Customer Service Executives (CSE).

### Content Management:

1. The first step in the process is to put together all products and brand information for the customer and also for the dealer/retailer and advertisers.

2. Product information is sourced and researched and put in the most easy to understand form for the benefit of the Customer—This information will include Technical Specifications, Comparative Information, Product Brochures, Photographs, Videos, Advertisement Films, Media Reviews, Customer Opinions etc.

### Dealer Shop & Price Management:

3. The next step is to get more and more dealers/retailers to join the network from different city to become part of the Network.

4. As the venture is location specific, dealers will also have to be managed location wise.

5. For each dealer, for the set of brands and products that he deals with, the shop has to be set up with the accurate price details and special offers that the dealer wants to give his customers.

### Brand Advertiser Management and Banner Advertisement Management:

6. After the Advertiser is set up, they will keep bidding higher Advertisement Budget on their brand to increase the Sales Incentive (in the form of Reward Points). This has to be approved by the Advertisement Manager.

7. Further to this, the Advertiser will use the Advertisement Management System to launch their Advertisement Campaigns. All campaigns will have to be approved by the Advertisement manager on an ongoing basis.

### Order Management:

8. Every customer's order will have to be managed by the e-retail administration manager using the backend Enterprise Management system to process the order through a Collaborative process between a Customer Service Executive, the Dealer and the Customer.

9. The customer service executive's work flow will also be managed through the system. As the customer service executive has to physically interact with customers and retailers, they also are assigned and managed on a location specific basis.

10. The customer's account will also be managed here to keep a track of closed orders and reward point redemption requests.

11. The dealer accounts will also be settled on a timely basis within the system.

12. The present invention can apply to specific categories of branded products and services with large advertising budgets. For E.g. Automobiles, Electronic Goods, Branded High Value FMCG, Consumer Durables, Jewelry, Apparels, Garments and Branded Financial Services. However the Process will vary depending on the category of Product that is being handled. The System will need a homogeneous method to handle such variations.

1-24. (canceled)

25. A method to offer best price deal and sharp targeted point of purchase advertisement in e-retail website, the method comprising the steps of:
a) receiving bids from brand marketers/advertisers of competitive brands, on the e-retail website wherein said bid represents the advertising budget to be spent by said brand marketer/advertiser, on a particular product;
b) classifying brands into homogenous categories and further into subcategories based on their market price range and ranking said brands in descending order, based on parameters comprising:
i. value of advertising budget entered by brand marketer/advertiser on said e-retail website;
ii. popularity of the brand leading to customer's “intention to purchase” the brand; and
iii. previous historic records of consistent expenditure on the advertisements by the brand marketers/advertisers on a period specific basis.
c) calculating the sales incentive to customer in the form of reward points for each product, based on the advertising budget;
d) displaying reward points against each product on said e-retail website;
e) providing reward points to customers when he selects a particular brand within said category and said subcategory; and
f) crediting said reward points to customer's account when said customer buys said brand wherein said customer has a registered account with the e-retail website.

26. The method as in claim 25, wherein each of said brand marketers/advertisers are provided with brand wise account information for authentication on the e-retail website whereby said brand marketers/advertisers can login and place bids anytime.

27. The method as in claim 25, wherein the product with the highest advertising budget, within said category and said sub-category gets the highest sales incentive which is further offered to every customer in the form of rewarding points whereby said customer gets reward point when he buys the brand and hence increase the sale of the brand that allocates the highest advertising budget.

28. The method as in claim 25, wherein said brand marketers/advertisers can change their advertising budget at any stage whereby changes the value of said reward points accordingly.

29. The method as in claim 28, wherein said value of said reward points increases or decreases everyday depending upon further bids being made by competitive brand marketers/advertisers and their advertising budget.

30. The method as in claim 25, wherein values of reward points with respect to various sub categories of products are also displayed within each sub-category.

31. The method as in claim 25, wherein said customer can choose any dealer, located in his neighborhood, to buy said product from, without affecting the value of said reward points whereby availing best discount on the products selected while buying from a dealer of his choice.

32. The method as in claim 31, wherein said dealer is at least one of:
a. distributor of the brands;
b. retailer of the brands;
c. seller of the brands.

33. The method as in claim 32, wherein said dealer is a registered member on the network that offers discounts on the products through e-shops on said e-retail website whereby said dealer can offer his competitive best price and special offers to the customers, leading to customers choosing said dealer over other competitive dealers in a locality, based on his best deal offer thereby increasing the sales for said dealer within shorter sales conversion cycles in comparison to a conventional physical shop.

34. The method as in claim 33, wherein all information including the best prices and special offers given by said dealer is authenticated, corrected, validated and approved by the e-retail administration manager whereby the customer is ensured that the deal promised by said dealer is always delivered as per commitment.

35. The method as in claim 32, wherein said dealer can select the brands of the products that he wants to sell through the e-retail website, and update his best price deal for said brand at anytime through his dealer account and the same will then be verified by the e-retail administration manager before it is displayed on the e-retail website.

36. The method as in claim 25, wherein the customer can place his order with any dealer by paying the booking amount using a credit card or any other method, whereby high value products can also be booked through said e-retail website.

37. The method as in claim 25, wherein reward points (if already available from past purchases) with the customer are automatically checked and validated for redemption before the payment is made.

38. The method as in claim 37, wherein the customer can redeem said reward points available in his account, before making the payment in which upon redemption, a 16 digit redemption code will be mailed to the customer which can be used while placing product orders with any dealer of his choice whereby the customer can avail discounts by choosing any product or brand that he wishes to buy from any dealer in a locality that he wants to buy it from.

39. The method as in claim 25, wherein, in case the customer is interested in buying a product on loan or in case said customer needs insurance, he can state his choice in the order form and the same will be taken care of by an offline support by said e-retail administration manager as part of the order fulfillment process.

40. The method as in claim 39, wherein upon receiving said order form, the following method is followed comprising the steps of:
d. e-retail administration manager receiving said order form;
e. assigning a customer service executive, in said locality, to said customer and forwarding him said customer's order information;
f. said customer service representative contacting said customer in order to process the order through the dealer of chosen by said customer;
g. organizing the loan and insurance as requested in order form in case said customer has opted for a loan or insurance;
h. processing loan through loan company of customer's choice and making payment to said dealer;
i. keeping product ready at the dealer's end;
j. delivering said product to said customer;
k. said customer confirming the acceptance of the delivery;
l. closing the order by said e-retail administration manager;
m. crediting said reward points to customer's account wherein the amount in the form of rewarding points, associated with a product bought by the customer, will be credited in his account which can be redeemed by the customer during his next purchase;
n. crediting said booking amount to dealer's account after said dealer has successfully delivered said brand ordered by said customer and the same order has been confirmed by the customer.

41. A system to offer best price deal and sharp targeted point of purchase advertisement in e-retail website, the system comprising:
o. an e-retail website providing a plurality of web pages to search for brands and browse through during decision making process while selecting the brand and short listing the product wherein said web pages provide different types of information, about the brand and comparative information about other brands in the same category and sub category, available to the customer for purchase through multiple dealers in a chosen locality whereby the customer can click various links and make choices;
p. a plurality of groups wherein each of said groups comprises a plurality of web pages bearing similar information based on closeness to a product decision finalization by the customer wherein the cost of advertising goes up as the customer moves to web pages in groups which are closer to the buying decision.
q. a plurality of advertisement banners of varying dimensions and positions wherein said advertisement banner being setup for each of said groups whereby relevant advertisements can be displayed on individual pages in order to target right customers.

42. The system as in claim 41, wherein said plurality of groups provide a plurality of options to advertisers to place their advertisement banner at different points on said e-retail website, depending upon:
r. sub category of product chosen by the customer;
s. the type of banner advertising option chosen by the customer; and
t. type of group of pages in the purchase process chosen for advertising;
whereby only relevant advertisement appears on each page depending upon the brand of the product displayed on the webpage, the subcategory of the product, and other brand choices of the customer, as tracked by the system, both in the current session as well as in the browsing sessions in the past login.

43. The system as in claim 41, wherein at any point of time, the advertiser can target customers at point-of-purchase of his brand/or any other competitive brand (in the same category/sub-category) and create a plurality of competitive brand communication campaigns, that vary, depending upon the other competitive brands that the customer is/was interested in, as tracked by his browsing patterns in the current session as well as in the past sessions.

44. The system as in claim 41, wherein the method to determine price of said advertisement banners that appear on a particular web page, comprises the steps of:
u. requiring the advertiser to login into his login account and complete his campaign set up for his brand across all advertising options on the online website so as to assign at least 90% to 110% of his total committed brand budget for the current time period (usually 4 months);
v. setting up a plurality of advertisements, with a plurality of creative banners wherein each of said creative banners of a fixed dimension is assigned to be displayed for a particular type of advertisement, within a particular group of web pages wherein advertiser can choose customer's interest in a particular competitive brand whereby different creative banners can be assigned to different customers depending upon their choice and preference for a particular brand;
w. advertiser bidding the highest price that he is willing to pay for display of said relevant advertisement within a certain group of web pages;
x. advertiser choosing the number of banner impressions that he wants to buy for said advertisement wherein said banner impression is the appearance of advertisement on a relevant web page;
y. computing the cost of each of said advertisement;
z. adding up a plurality of said advertisements, set up by the advertiser, to complete the campaign when the total value is at least 90% to 110% of the total advertising budget wherein said advertiser can edit his campaigns any time however the campaign will not be complete till total value of said advertisement is not at least 90% to 110%;
aa. estimating on an everyday basis, the number of banner impressions available on the e-retail website, within a category and sub category for the next day, based on at least 45 day performance pattern of said sub category in the past, for each type of advertising and for each group of pages;
bb. computing on an everyday basis, the demand for the said banner impressions for the next day within each sub category, for each type of advertising and for each said group of web pages, based on a plurality of campaign sets of all multiple brand advertisers in the same category and sub category;
cc. matching the demand for the next day based on campaigns set with estimated supply of banner impressions for the next day and thereby computing the optimum price for each of said banner impression;
dd. prioritizing campaigns of the advertisers with higher bids wherein the campaigns of the advertisers whose highest bid falls below the computed price for the day, will not be displayed on the web pages and said advertisers will be alerted to allow them to upgrade their bids for the next day.
